(19) United States
(12) Patent Application Publication
(10) Pub. No.: US 2010/0019459 A1
(43) Pub. Date: Jan. 28, 2010

(54) FLAT SEAL FOR HIGH LOADING FOR INTERNAL COMBUSTION ENGINES

(76) Inventor: Ralf Salameh, Gondelsheim (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/279,763

(22) PCT Filed: Jan. 18, 2007
(86) PCT No.: PCT/EP07/00436

§ 371 Date: Jun. 26, 2009

(30) Foreign Application Priority Data
Feb. 16, 2006 (DE) 10 2006 007 311.8

(51) Int. Cl. F02F 11/00

(52) U.S. Cl. 277/592; 277/595

(57) ABSTRACT

A flat seal with increased wear resistance with respect to relative movements and local excess pressure includes a base support plate provided with profiling on both sides in the region of the fastening of the seal, which profilings lead to the surface being enlarge in this region and hence the forces being reduced, and also cause an increase in the friction or even a toothing effect with the pressed-on flanges. The profilings can lie freely or can be additionally coated or filled with an elastomer material. Through the local separation of functions which is thus achieved between sealing effect and fastening effect, a flat seal is provided which shows less wear and is therefore able to function for longer, without additional elements or costly processing steps being necessary.

The invention relates to a flat seal for high stress with increased wear resistance to damage by local excess pressure and relative movements, in particular for internal combustion engines.

Compared with other types of seal, e.g. those with a metallic supporting frame, flat seals are distinguished in that the various functions of the sealing element, namely the sealing function and the transmission of the screwing forces, are not separated from each other. The sealing function of a flat seal is achieved by pressing the seal. With a separation of function, on the other hand, the rigid metallic supporting frame undertakes the function of the force transmission and produces a defined sealing gap, in which an elastic sealing material is pressed.

Known basic types of flat seal are, for example, paper seals or seals of a metallic base support coated with elastomer. Here, normally the elastomer coating is corrugated to increase pressure. A possible embodiment is described for example in EP 1023549, in which here the elastomer material has in addition encircling elevations which form sealing lips.

Such seals are used in areas in which no particularly great component tolerances have to be balanced out. All these flat seals have in common the fact that they lie in the flux of force of the housing- or flange screw couplings and therefore are highly stressed by the screwing forces. Different contact patterns in the sealing path are produced by different housing shapes and screw coupling arrangements.

By relative movements and high surface pressures between the flanges, between which the seals are pressed in, flat seals can, however, be damaged to a greater or lesser extent. Such relative movements occur for example when flat seals are used in movable arrangements, such as in an engine, and can not be prevented. Also, the high bearing pressure can not be substantially reduced, owing to the structural form, because otherwise the sealing effect of the flat seal is reduced. Vice versa, a further increase to the bearing pressure or to the screwing forces could in fact reduce the relative movements, but would also cause an increased stressing of the seal. The damage and mechanical wear phenomena can, finally, lead to a failure of the sealing function.

The critical areas in which these wear phenomena principally occur generally lie in the region of the screw couplings. A small flange surface or contact: surface of the seal can also lead to a high stress in local areas.

This type of known flat seal can therefore often not be used in the case of locally very high pressures and/or deformations of housing components and in the case of relative movements. This applies especially in more highly stressed housings with high screwing forces and small flange- or contact surfaces. In such cases, often a different, generally more expensive type of seal construction must therefore be selected, for example a seal with a metallic supporting frame onto which the sealing lips are vulcanized on the end side. In such a seal, a separation of functions is again present, because the transmission of the over-screwing forces and the sealing function are ensured by different parts of the seal.

It is therefore an object of the invention to provide a flat seal in which, without the inclusion of additional components, a relieving of the load of these critical areas is achieved, so that damage due to the mentioned relative movements and excess pressures is reduced or completely avoided and the lifespan of the seal is thus distinctly increased.

The problem is solved by a flat seal according to claim 1, which has a metallic base support with at least one sealing zone, in which the base support is provided in at least one pre-determined zone outside the at least one sealing zone at least partially with a functional structure which has imprinted profilings of the base support.

Through such a structuring, which is worked out from the actual seal, a type of local separation of functions of a one-piece seal is brought about, because now the force transmission takes place in an intensified manner or principally in the effectively thickened regions of the seal. The regions of the flat seal which ensure the sealing function are thereby stressed significantly less. In addition, through the structure and form of the profiling, the friction between seal and flanges is increased or even a toothing of the elements is brought about, so that the relative movements are reduced.

In a preferred embodiment, the base support has one or more fastening openings, and the functional structures are adjacent to these fastening openings. The openings usually serve as screwing holes, for which reason the pressing forces through screwing are highest in these regions.

The fastening openings are preferably circular, and each fastening opening is surrounded at an angle of approximately 180° by a functional structure.

It is, in addition, preferred that the impressed profilings of the functional structure are constructed symmetrically on both sides of the metallic base support.

The profilings are preferably distributed uniformly in the loading zone. Thereby, as uniform a loading as possible of the seal is ensured.

In one embodiment, the profilings are continuous and cause a perforating of the metallic base support. The continuous perforations lead respectively to edges which can further contribute to an increase in friction and to toothing up to a plastic penetration into the flanges.

In a preferred embodiment, the profile elements are hemispherical. As is known, a spherical surface is particularly stable with respect to deformations under stress.

In a further preferred embodiment, the profile elements are cylindrical or parallelepiped in form. This form is very simple to produce with a desired depth of impression and offers a high friction by the surfaces lying adjacent to the flanges.

According to a further preferred embodiment, the profile elements are tapered or pyramidal. The tips of these profile elements can favour an intensive toothing of the elements.

The base support of the flat seal is preferably produced from a steel plate. This is a proven and usual material for such support plates.

It is further preferred that the flat seal is provided at least partially with a coating of an elastomer material. Here, a liquid-elastomer coating is preferred, which is known as LEM (liquid elastomer moulding).

Here, in one embodiment, the flat seal is provided in the sealing areas with one or more elastomer sealing lips. The sealing function is thereby improved at suitable locations.

In a preferred embodiment of the invention, at least the functional structure is provided with the elastomer coating. Such a coating of the functional structure can additionally increase its rigidity.

It is further preferred that the thickness of the elastomer coating of the functional structures corresponds to height of the stampings. In this way, edges and upper surfaces of the structure continue to lie free and provide for an increased friction with the flanges, whilst the increased rigidity of the structure is maintained as described above.

In a further embodiment, the functional structure is removed from the elastomer coating.

In one embodiment, it is preferred that the overall thickness of the elastomer-coated flat seal corresponds to the overall thickness of the elastomer-coated functional structures, and that the overall thickness of the elastomer-coated structures is greater than the thickness, measured uncoated, of the functional structures. The flat seal therefore has the same thickness throughout and can be adapted precisely, whilst in addition all the surfaces of the functional structure are also coated with elastomer.

The dimensions of a preferred embodiment of the invention are such that the base support plate has a thickness between 0.2 and 1 mm, the overall thickness of the flat seal is between 0.4 and 1.2 mm and the uncoated measured thickness of the functional structures is 0.3 to 1 mm.

It is preferred that the profilings of the functional structure are produced by impressing the base support plate.

### BRIEF DESCRIPTION OF THE DRAWINGS

The invention is described in detail below with the aid of example embodiments and drawings.

FIGS. 1a and 1b show the structure of a flat seal with elastomer coating according to the prior art.

FIG. 2 shows an embodiment of a flat seal according to the invention with a region which is provided with a functional structure.

FIG. 3a shows a cross-section through a flat seal according to the prior art.

FIG. 3b shows in cross-section an embodiment of a flat seal according to the invention with an uncoated functional structure.

FIG. 3c shows in cross-section an embodiment according to the invention with an elastomer-coated functional structure.

FIG. 3d shows in cross-section a further embodiment according to the invention with an elastomer-coated functional structure, in which the coating is applied only up to the height of the profilings.

FIG. 4a shows a diagrammatic cross-section of an embodiment of the functional structure of the invention with closed pyramidal or tapered profile elements.

FIG. 4b shows a further embodiment of the functional structure with pyramidal/tapered elements, in which the elements are directly adjacent to each other.

FIG. 4c shows a further embodiment of the functional structure with closed cylindrical or parallelepiped elements.

FIG. 4d shows a further embodiment of the functional structure with closed hemispherical elements.

FIG. 4e shows an embodiment of the functional structure of the invention with open tapered elements.

### DETAILED DESCRIPTION OF THE INVENTION

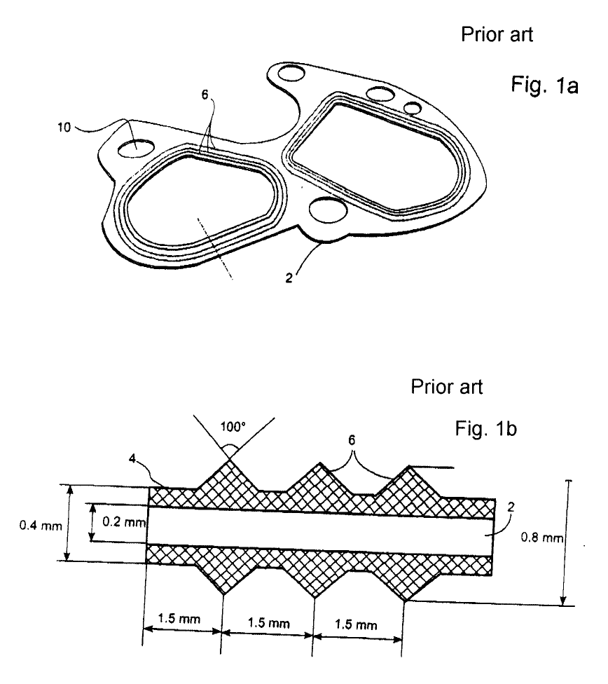

FIG. 1 shows a flat seal 1 by way of example, according to the prior art. In FIG. 1a, a perspective view can be seen, whilst in FIG. 1b a cross-section is illustrated. The seal has a metallic base support 2 and is coated with an elastomer material 4. In addition, several, in this case three, sealing lips 6 which run parallel are made from the elastomer material. These have a triangular cross-section and run, as shown in FIG. 1a, respectively around the whole sealing opening. The seal has fastening openings 10 for screwing with other components.

Further details of the seal, such as additional sealing elements, corrugations etc. are not shown here, but are known to the specialist in the art. As shown in FIG. 1b, example dimensions for the various elements of the seal are as follows: the metallic core 2 has a thickness a of 0.2 mm, the overall thickness x of the seal is 0.4 mm, so that in this example an elastomer coating 4 of 0.1 mm thickness is applied on each side. The thickness of the flat seal, measured up to the tips of the sealing lips 6, amounts to 0.8 mm. The enclosed angle of the triangular sealing lips 6, which lie respectively 1.5 mm apart from each other (from tip to tip) is to be approximately 100°. However, depending on the application, the dimensions of the flat seal can of course also deviate from these values.

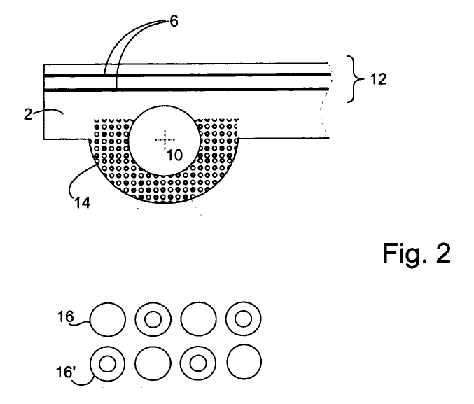

FIG. 2 shows by way of example a cut-out of a flat seal which has a region which is provided with a functional structure according to the invention. The size of the structured region 14 is not fixedly predetermined, but is selected according to the purpose of use of the seal and expected load distribution on manufacture. In this case, the functional structure is situated adjacent to a fastening opening 10, which serves for screwing the flat seal 1 between the flanges (not shown). The fastening opening 10 is only partially surrounded by the functional structure 14, and in fact preferably with an approximately semicircular region. On the opposite side of the fastening opening 10, two sealing lips 6 are situated, so that no functional structure is possible there. The sealing region, which also comprises the sealing lips, is Designated below by 12. The diagrammatic enlargement of the functional structure shows the regularly alternating arrangement, symmetrical on both sides, of individual profile elements 16 and 16′, in which the elements impressed from one side are designated by 16 and the elements which are impressed from the other side of the base support but are otherwise identical are designated by 16′. The precise form of this functional structure is described in further detail below.

As the critical stresses in fact generally occur, owing to the force transmission through screwing, in the region of the fastening openings or screwing holes 10, but not exclusively there, such functional structures 14 can alternatively or additionally also be arranged at other suitable locations on a flat seal, in which the region of the functional structures 14 must lie outside the sealing regions 12, in order to further ensure the sealing function. The most favourable position of these locations, which results from the load distribution of the seal, can be determined by means of any desired suitable method. Intensive stresses and wear phenomena also occur, inter alia, in the case of very small flange surfaces and contact surfaces of the seal.

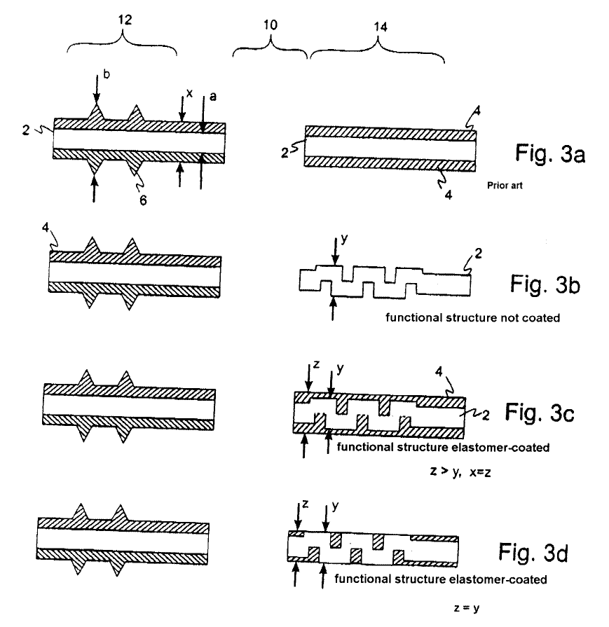

In FIG. 3 cross-sections are illustrated through various embodiments of flat seals. FIG. 3a is a cross-section through an embodiment according to the prior art, i.e. without impressed functional structure. The various regions otherwise correspond to the regions shown in FIG. 2. In the centre, as also in FIG. 1, the base support 2 is situated, which consists of a metal plate. This base support 2 is coated on both sides with an elastomer 4, and namely in this example both in the fastening region which is adjacent to the fastening opening 10, and also in the sealing region 12. Here, on both surfaces of the seal, respectively two sealing lips 6 can be seen, which are formed out of the elastomer coating 4. The elastomer sealing lips 6 preferably have a triangular cross-section, but could also be present in a different shape; in addition, the embodiment, number and arrangement of the sealing lips 6 is dependent on the application and variable, as will be obvious to the specialist in the art.

As a comparison to this coated flat seal according to the prior art, in FIG. 3b a first embodiment of a flat seal according to the invention is shown. Here, the base support 2 is identical in the sealing region to the seal shown in FIG. 3a, i.e. coated on both sides with an elastomer 4 and provided with sealing lips 6. However, the fastening region is distinctly different. This region 14 was provided with symmetrical profilings or structurings on both sides, and in addition this region 14, which is designated below as a functional structure, is not coated with elastomer. The profilings can be produced in various suitable forms and are preferably impressed hollow out of the support plate from both sides.

The elevations in the region of the functional structure act as a local thickening of the base support of the flat seal, without requiring additional material. The structure of the profiling contributes in addition on the one hand to the increase of friction, as is explained below; on the other hand, the rigidity and the deformation characteristics of the seal can be influenced in a comprehensive manner by means of the form of the profiling.

In this way, the stressing of the seal with respect to surface pressure and relative movement is reduced to non-critical values, which consequently leads to a distinctly reduced wear of the seal and therefore makes a longer lifespan possible.

As already in the flat seal according to the prior art, in one embodiment the support plate thickness a can be between approximately 0.2 to 1 mm, in which the over all thickness x together with the elastomer coating is as a whole approximately 0.4 to 1.2 mm. In the region of the functional structure, the thickness y, which extends from the lower end of the profile elevations 16, 16′ up to the upper end of the profilings, is approximately 0.3 to 1 mm.

A similar example embodiment of the invention can be seen in FIG. 3c, in which now, again, the entire sealing element is provided with an elastomer coating 4, also the region of the functional structure 14. The coating (an be so thick that the entire flat seal, i.e. both in the sealing region 12 and also in the region of the functional structure 14, has the same overall thickness z=x, in which the coating 4 in a preferred embodiment is so that that it exceeds the functional structure. Alternatively, the elastomer, as in FIG. 3d, can only be applied up to a height z such that the depressions occurring through the profilings 16, 16′ are filled out precisely. The remaining flat seal can then, as in the example of FIG. 3c, be coated so that the flat seal has the same overall thickness throughout, but it could also show different coating thicknesses at various locations. A filling or coating of the profilings with the elastomer brings about an additional increase to the rigidity in this region and influences the deformation characteristic of the flat seal. Apart from the coating thickness, for example dimensions are possible as indicated above for the description of FIG. 3b.

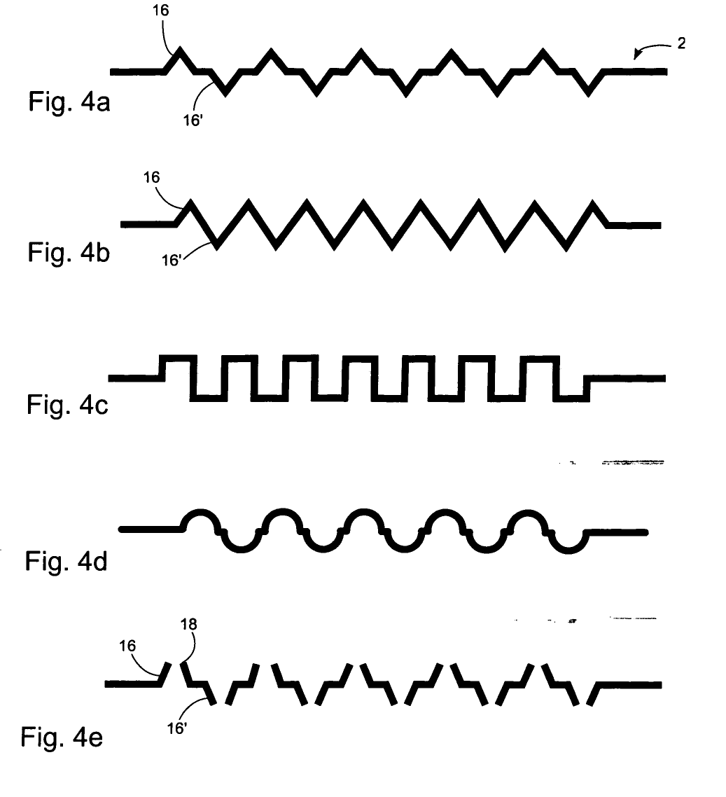

The profilings or the functional structure in the critical regions can be embodied and arranged in a variety of different forms. Preferably, the profilings are formed on both sides, i.e. by impressing in both directions of the metal support plate. Here, the functional structure 14 or the profiling comprises a plurality of individual profile elements 16, 16′ of suitable form which, distributed over the desired region, are impressed from both sides. It is advantageous here for a uniform force distribution and toothing effect that the profile elements 16, 16′ are impressed symmetrically and alternately from both sides, as can be seen from FIGS. 3 and 4.

Thus, the profilings could comprise pyramidal or tapered elements which therefore taper towards the outside acutely, perpendicularly to the plane of the flat seal, as shown in FIGS. 4a and 4b. The tips of such a shape, in addition to the effective thickening of the seal at this location can bring about a toothing of the profilings with the flanges adjacent thereto. A larger support surface and hence greater friction is achieved for example by cylindrical or parallelepiped-shaped elements which are illustrated in turn in cross-section in FIG. 4c. The profilings could also be present in the form of hemispherical profile elements (see FIG. 4d), whereby stresses are distributed particularly uniformly and effectively. Furthermore, any desired suitable form is conceivable. The aim in all the embodiments is to be to produce a surface which equals a thickening of the metallic base support. Here, in addition, the geometry of the profilings is selected so that in these regions an increase of the friction coefficients occurs up to a toothing effect between the seal and the flanges and thereby the relative movements between the components are minimized. In this way, the functional structure serves as a kind of force- and path limiter for the seal.

In various embodiments, the functional structures can be formed in addition so that parts of the functional structure penetrate in a plastic manner into the flange surface and fix the components. Owing to the different hardness of the materials, this applies in particular when, as usual, a steel plate is used as base support material of the flat seal, and the flanges are made from aluminium. Such a fixing can be achieved for example when, as described above, profile elements are selected which taper acutely. A further possibility is to produce the profilings so that the support plate is perforated, i.e. with open profile elements, as shown in FIG. 4e. In this example embodiment, the profile elements 16 and 16′ are constructed so as to be tapered and open, so that respectively approximately circular edges 18 of the support plate are produced, which can then engage with the flanges.

The size of the functional structure can be adapted in every respect to the component conditions, for example to materials used, acting forces and particular stresses etc. Here, of course, both the surface of the impressed region and also the size of the individual profile elements is variable. The elements can be respectively directly adjacent to each other, but they can also be situated at regular intervals from each other. These two possibilities are contrasted with each other as a comparison for the case of the tapered or cylindrical profile elements in FIGS. 4a and 4b. Of course, this also applies to the remaining possible embodiments, but was not described in further detail there. In addition, the possibility exists of combining profile elements of different shape within a structured region, so that for example alternately different forms are arranged adjacent to each other, in order to thus combine the advantages of two embodiments in an optimum manner.

As this type of flat seal with metal support is typically made from a coil and passes through various process steps up to the punching out of the seal, the production of the functional structure can be integrated very simply into the punching process, without additional expenditure. It is also conceivable here that for simplification, various standardized press dies are used, with frequently recurring elements, such as for example screw profiles M6 or M8. The pressed out functional structure can be specifically influenced in its rigidity by its geometry and the deformation brought about thereby, and by cold work-hardening processes, in order to obtain ideal results for the respective application.

Therefore, to also adapt the flat seal according to the invention to high pressure forces and intensive relative movements, no further elements are necessary, and a simple integration into existing manufacturing processes is possible.

Various embodiments of the invention were illustrated and described above. However, it is obvious to the specialist in the art that these were only named as Examples and are not intended to limit the scope of protection of the invention; changes within the framework of the enclosed claims are possible in various ways.

1. A flat seal for high stress, comprising a metallic base support with at least one sealing region wherein, the base support is provided in at least one pre-determined region outside the sealing regions at least partially with a functional structure, which has impressed profilings of the base support.

2. The flat seal according to claim 1, in which the base support comprises one or more fastening openings, and in which the functional structures are adjacent to the fastening openings.

3. The flat seal according to claim 2, in which the fastening openings are circular, and in which each fastening opening is surrounded at an angle of approximately 180° by a functional structure.

4. The flat seal according to claim 1, in which the impressed profilings are formed symmetrically and alternately on both sides of the metallic base support.

5. The flat seal according to claim 1, in which the profilings are continuous and bring about a perforating of the metallic base support.

6. The flat seal according to claim 1, in which the profilings are distributed uniformly over the predetermined region of the functional structure

7. The flat seal according to claim 1, in which the individual profile elements are hemispherical.

8. The flat seal according to claim 1, in which the profile elements are cylindrical or parallelepiped in shape.

9. The flat seal according to claim 1, in which the profile elements are tapered.

10. The flat seal according to claim 1, in which the profile elements are pyramidal.

11. The flat seal according to claim 1, in which the base support is made from a steel plate.

12. The flat seal according to claim 1, in which the base support is provided at least partially with a coating of an elastomer material.

13. The flat seal according to claim 1, in which the flat seal is provided in the sealing regions with one or more elastomer sealing lips.

14. The flat seal according to claim 12, in which at least the functional structure is provided with the elastomer coating.

15. The flat seal according to claim 14, wherein the thickness of the elastomer coating of the functional structures corresponds to the height of the impressions.

16. The flat seal according to claim 12, in which the functional structures are removed from the elastomer coating.

17. The flat seal according to any of claims 12, in which the overall thickness (x) of the elastomer-coated flat seal corresponds to the overall thickness (z) of the elastomer-coated functional structures, and in which the overall thickness (z) of the elastomer-coated functional structures is greater than the thickness (y), measured uncoated, of the functional structures.

18. The flat seal according to claim 17, in which the base support plate has a thickness (a) between 0.2 and 1 mm, the overall thickness (x) of the flat seal is between 0.4 and 1.2 mm and the thickness (y), measured uncoated, of the functional structures is 0.3 to 1 mm.

19. The flat seal according to claim 1, in which the profilings of the functional structure are produced by impressing.
